(19) United States
(12) Patent Application Publication
(10) Pub. No.: US 2026/0100850 A1
(43) Pub. Date: Apr. 9, 2026

(54) REAL TIME LOAD AND ENERGY MANAGEMENT OF DISTRIBUTED ENERGY RESOURCES

(71) Applicant: Itron, Inc., Liberty Lake, WA (US)

(72) Inventors: Sasha Yegorov, San Francisco, CA (US); Michael Ting, Oakland, CA (US); Jeffrey Scott Bailey, Coeur dAlene, ID (US)

(21) Appl. No.: 19/280,069

(22) Filed: Jul. 24, 2025

Related U.S. Application Data
(60) Provisional application No. 63/703,776, filed on Oct. 4, 2024.

(51) Int. Cl. H04L 9/32

(52) U.S. Cl. CPC H04L 9/3263

(57) ABSTRACT

Techniques for allocating a load capacity to on-site smart sensors coupled to distributed energy resources (DERs) are described herein. For example, a management application may include load limiting logic configured to monitor total load at a site periodically (e.g., at 1 second intervals). In some examples, when an EV charging session is initiated by a customer, the management application may determine a total site load relative to a maximum EV charging load. In response to the total site load exceeding a threshold, such as a rated capacity of the service panel, the management application may throttle the EV charging load such that total site load stays below the threshold (e.g., within rated capacity). In some cases, in response to the total premise load declining below the threshold, the management application may increase the EV charging limit.

### CROSS-REFERENCE TO RELATED APPLICATIONS

This application claims priority to U.S. Provisional Application No. 63/703,776, titled “Real Time Load and Energy Management of Distributed Energy Resources,” filed Oct. 4, 2024, which is hereby incorporated by reference in its entirety.

### BACKGROUND

Adopting electric vehicles often requires upgrading the utility electrical service to the premise due the magnitude of electric vehicle charging relative to other residential loads. In turn, upgrading electrical service adds significant extra costs and time for both consumers (in the form of upgrading the distribution service panel) and electric distribution utilities (in the form of upgrading service conductors, shared secondary conductors, and service transformers) to safely connect and operate new electric vehicle (EV) chargers

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1A illustrates an example power distribution environment.

FIG. 1B illustrates example components of a utility meter located in a power distribution environment.

FIG. 2 illustrates another example power distribution environment.

FIG. 3 is a block diagram illustrating details of one of the example smart utility meters.

FIG. 4 illustrates an example process for real time load management of a distributed energy resource.

FIG. 5 illustrates another example process for real time load management of a distributed energy resource.

### DETAILED DESCRIPTION

Systems and methods for managing distribution of electrical power and loads are disclosed. In some cases, a smart utility meter may run an application that measures a load on the customer panel, a service wire, and/or a service transformer and post a limit to the charger, which may avoid the need for an upgrade to electrical infrastructure in order to support additional loads. For example, modern electric vehicle supply equipment (EVSEs) may draw up to 40-60 amp loads within a site (e.g., a home). Sites with 100-amp service, such as most homes, may require an upgrade to 200-amp service to accommodate safe installation of EVSEs in most cases. Even homes with 200-amp service may require service upgrades when those homes already have other services that draw significant power, such as air conditioning. Upgrading electrical service triggers additional out-of-pocket costs to consumers and utilities that can be significant as well as taking months to complete. An EVSE management application (sometimes referred to as a “management application,” an “energy management system (EMS) application,” or an “electricity usage application”) stored on a smart utility meter may dynamically throttle EV charging load in response to other loads at the premise to keep total load within the capacity of the distribution panel. In some cases, the EMS application may reside on other devices. For instance, the EMS application may reside in an electrical panel, a transformer, a home hub, and/or the EVSE In this way, the process may enable a customer to avoid a panel or service upgrade by connecting their EV charger wirelessly to a smart utility meter and/or other devices monitoring local energy consumption at the service site.

In some cases, the management application may include load limiting logic configured to continually and/or periodically monitor total load at the site (e.g., 1 second intervals). In some examples, when an EV charging session is initiated by the customer, the management application may determine a total site load relative to a maximum EV charging load. In response to the total premise load exceeding a threshold, such as, a rated capacity of the service panel, the management application may responsively (e.g., within 1 second) throttle the EV charging load such that total premise load stays within rated capacity. In some cases, the threshold may include a rated capacity of the service panel, it could be based on a rated capacity of the transformer, or another threshold value. In some cases, in response to the total premise load declining below the rated capacity of the service panel, the management application may increase the EV charging limit.

In some cases, the smart utility meter may include a Wi-Fi radio and ability to run custom applications. In some cases, the utility meter may communicate using any and/or all communication techniques, such as Bluetooth, Zigbee, cellular communication, and/or power line communication (PLC). In some examples, the applications (e.g., the management application may include a charging program which may run on the meter and connect to the EV charger and send site limits to ensure grid limits are met). In some cases, the EV charger may be owned by the customer with load management firmware associated with particular EV chargers (with, e.g., Tesla, Emporia, Wallbox, etc.). In some examples, a cloud infrastructure may include a distributed intelligence (DI) platform running in a cloud environment to support the smart utility meter functions.

In some examples, the process may include establishing a repeatable and reliable process for the customer or installer to enable Wi-Fi connectivity between the smart utility meter and EVSE. In some cases, this includes implementing discovery capability between the smart utility meter and EVSE using self-service via the device and/or supporting applications. For example, a EVSE control agent hosted on the utility meter may be able to communicate locally over Wi-Fi with the EVSE to provide load management of the EVSE. In some cases, the EVSE may also be connected to the original equipment manufacturer (OEM) charge station management system (CSMS) via the cloud and may get real time load management signals from the OEM CSMS.

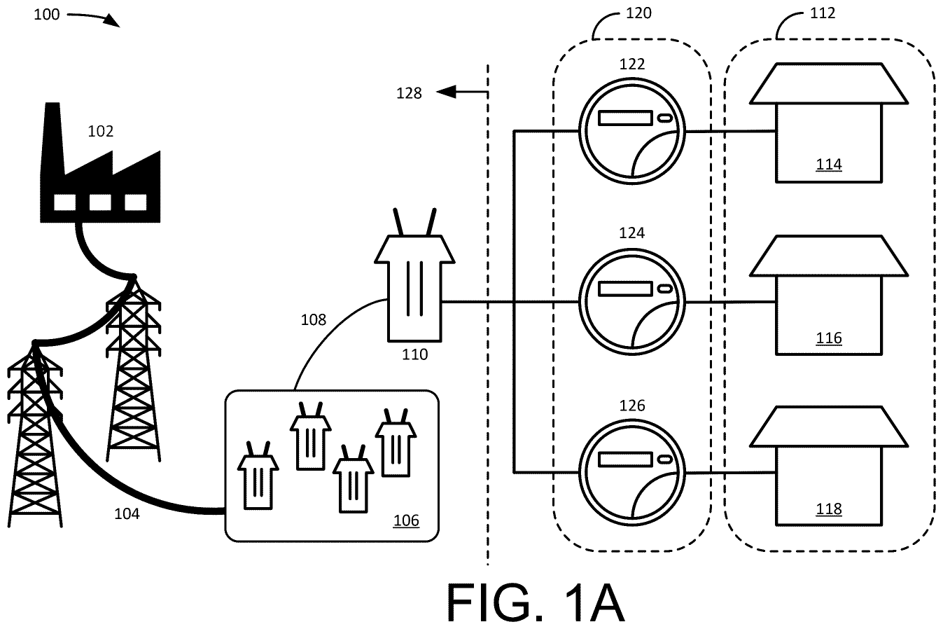

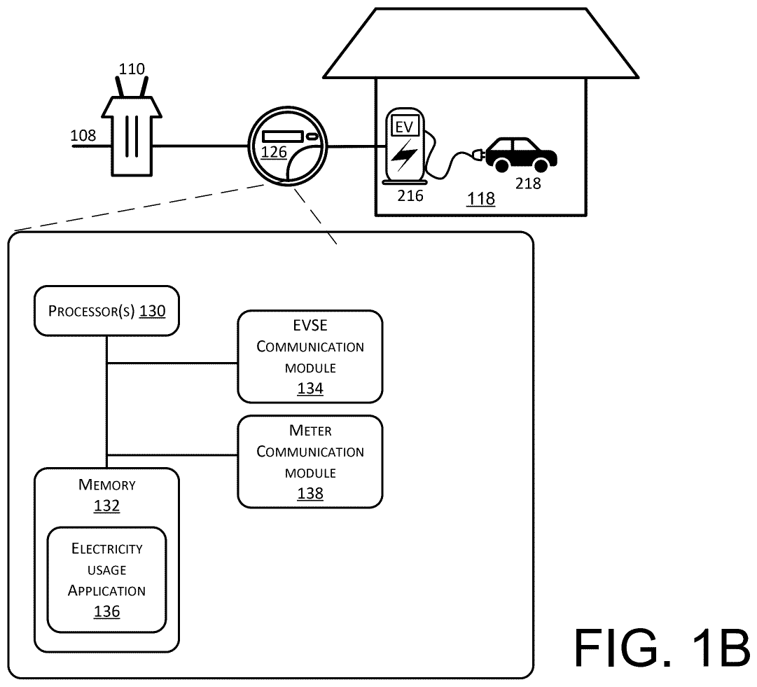

FIG. 1A illustrates an example power distribution environment 100. In this example, a power plant 102 generates electricity, which is carried by high voltage lines, or transmission lines 104, to a power substation 106. The power plant 102 represents one or more power plants based on traditional centrally generated energy sources such as fossil fuel, hydroelectric, and/or nuclear, as well as renewable energy sources such as wind and solar. The power substation 106 provides electricity via a feeder 108 to a transformer 110. The feeder 108 is a power line consisting of individual powered lines servicing a plurality of premises 112 (three individual premises 114, 116, and 118 are shown in this example though the number of premises can be more or less in other examples) connected via the transformer 110 and a plurality of electricity metering devices 120 (three individual electricity meters 122, 124, and 126 as electricity metering devices are shown in this example) associated the plurality of premises 112. The plurality of premises 112 may include residential premises, commercial premises, either of which may have electric vehicle supply equipment (EVSE), and the like. In this example, the transformer 110 is shown to be connected to the feeder 108 and represents a connection to a portion of the electrical grid 128 which comprises power plants 102, power substations 106, transmission lines 104, and other electric components (not shown). FIG. 1A is a simplified example, and in practice any number (tens, hundreds, thousands, or more) of each of the illustrated components may be present. In some cases, the environment 100 may include local energy generation and storage, such as solar panels and/or battery storage devices at the service site. In some cases, the EMS application may take into account the local power generation and storage in determining when to charge the EV.

FIG. 1B illustrates the premises 118 as including an electric vehicle supply equipment (EVSE) 218 as a distributed generation system. The EVSE 218 may charge an electric vehicle (EV) 218 when the EVSE 218 is plugged into EV 218. Additionally, or alternatively, the EVSE 218 may charge the EV 218 based on a charging schedule. For example, while the EVSE 218 is plugged into EV 218, the EVSE 218 may become active only during a scheduled time, such as during non-peak hours (between 10 pm and 6 am for example), to charge the EV 218. The EVSE 218 may also be set to charge the EV 218 at a certain battery charging rate and/or when the cost of electricity, such as $/kWh, is below a preselected cost. Additionally, or alternatively, the EVSE 218 may also direct, or be instructed to direct, the stored electricity from a battery or batteries of the EV 218 to the electrical grid 128 during a peak demand period.

Although the premises 118 illustrates the EVSE 218 as drawing electrical load from the electricity meter 126, it should be understood that other devices and/or equipment may be coupled with the electricity meter 126 and in communication with the electricity usage application 136. For instance, the premises 118 may include a location without an EVSE but that does include lights, appliances, and/or other electrical equipment capable of load balancing via the electricity usage application 136.

FIG. 1B illustrates electricity metering device 126 being utilized to provide power to the EVSE 218. The demand may in some circumstances exceed the available power due to a number of reasons, such as many consumers simultaneously charging electric vehicles at night at home, extreme weather conditions in which a large number of consumers are expected to continuously use heating or cooling equipment, or the like. The demand may also exceed the available power due to variations in power production (e.g., at night for solar power generation, on days with little or no wind for wind generation, etc.), if one or more power generators or sources go offline, and/or if some transmission lines become disconnected and fail to provide power from the generators to some parts of the electrical grid 128. To maintain the integrity of the electrical grid 128 and avoid a catastrophic grid failure, the demand needs be reduced, or the supply, at least temporarily, needs to be increased.

In some cases, the demand may need to be reduced and/or increased based on other factors, such as external safety constraints. In some cases, this may include service conductor rating, transformer rating, electrical panel rating, etc.

The electricity meter 126 may comprise one or more processors 130, memory 132 communicatively coupled to the processors 130, an EVSE communication module 134, and a meter communication module 138 communicatively coupled to the processors 130 and the memory 132. The processors 130 and/or memory 132 may include hardware device(s), such as an application specific integrated circuit (ASIC), a gate array or other hardware-based logic device. When present, the processor(s) 130 may comprise microprocessors, central processing units, graphics processing units, or other processors usable to execute program instructions to implement the functionality described herein. Additionally, or alternatively, in some examples, some or all of the functions described may be performed in hardware. In some cases, the memory 132 includes an operating system (OS) and one or more applications that are executable by the processor(s) 130. The memory 132 may also include a metrology module configured to receive, interpret, and/or otherwise process the metrology data collected by the electricity meter 126. Additionally, or alternatively, one or more of the applications may be configured to receive and/or act on data collected by the electricity meter 126. The memory 132 may also include one or more communication stacks (not shown). In some examples, the communication stack(s) may be configured to implement a 6LowPAN protocol, an 802.15.4e (TDMA CSM/CA) protocol, and/or an 802.15.4g protocol. However, in other examples, other protocols may be used, depending on the networks with which the device is intended to be compatible.

In some examples, the electricity meter 126 may utilize the EVSE communication module 134 to communicate with local distributed energy resource (DER) devices (such as the EVSE 218) and may utilize the meter communication module 138 to communicate via an advanced metering infrastructure (AMI) network. For example, the meter communication module 138 may be configured to utilize hardware (HW) interfaces of the electricity meter 126 in order to communicate, such as but not limited to Wi-Fi, Ethernet, Powerline, Zigbee, and/or Modbus. In some cases, the meter communication module 138 may be configured to communicate with multiple devices in parallel through HW interfaces (e.g., Wi-Fi) allowing to run multiple software (SW) communication protocols on top, such as but not limited to, OCPP, IEEE 2030.5, application protocol interfaces (APIs). In some cases, the electricity meter 126 may receive, or collect, via the EVSE communication module 134, the meter communication module 138 and/or an electricity usage application 136; and store in the memory 132, various factors, parameters, and conditions including the overall load or the demand, the load forecast, the EV load, the battery levels of batteries connected to the electrical grid, the weather information including the current weather and forecast, and the like as described above. The electricity meter 126 may also receive electricity usage data from the plurality of electricity metering devices 120 via the meter communication module 138 and/or the electricity usage application 136. The electricity usage data may include present, or real-time, electricity consumption data associated with the plurality of premises 112, historical electricity consumption data associated with the plurality of premises 112, present, or real-time, electricity generation data associated with the one or more distributed generation systems (e.g., EVSE 218), and historical electricity generation data associated with the one or more distributed generation systems. The historical electricity consumption data may include electricity usage or consumption amount by the plurality of premises 112 and electricity generated by the distributed generation system (when used as a supply) based on seasons, day-of-the-month, day-of-the-week, time-of-the-day, weather and temperature conditions, EV-related usage, and the like.

The software and or functionality of the tool(s), system(s), resource(s), cloud(s), platform(s), etc., discussed above with reference to FIGS. 1A and 1B regarding the electricity meter 126 may be combined in different ways depending on design requirements, ease of construction and/or integration, cost, etc. Accordingly, while these elements have been separated for purposes of discussion, they may be combined, as appropriate, during implementation.

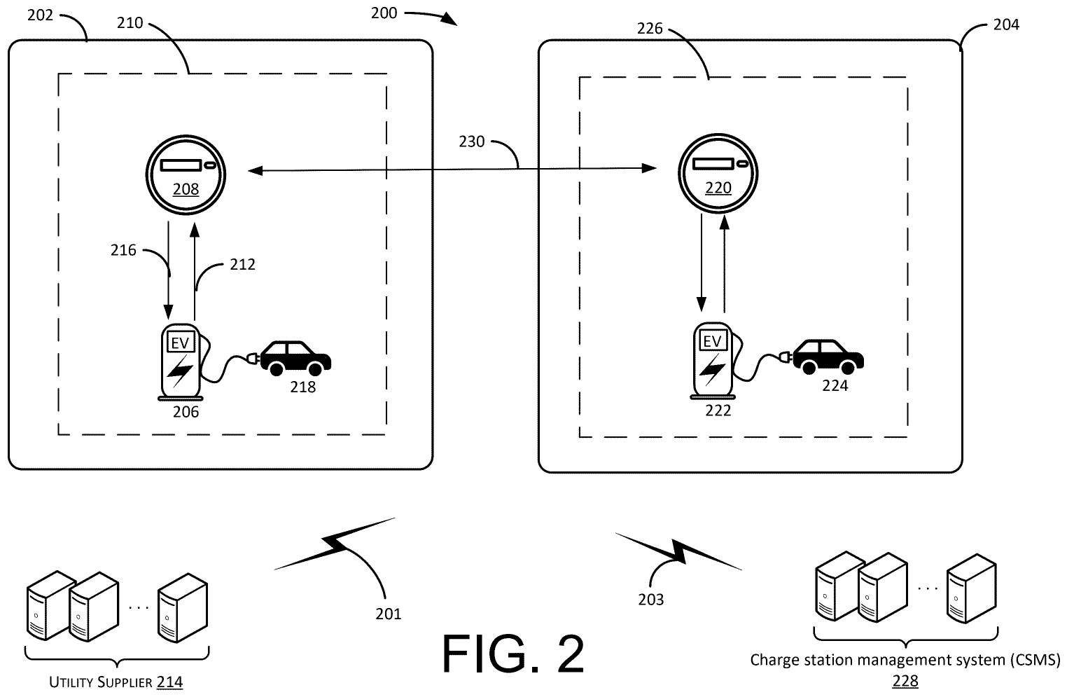

FIG. 2 illustrates an environment 200 that includes site 202 and site 204 operating within in an energy management system (EMS). In some examples, the site 202 and the site 204 may be similar to or the same as the premises 118 as described herein. In some cases, a user and/or installers may set Wi-Fi connectivity of a EVSE 206 and a smart utility meter 208. Both the smart utility meter 208 and the EVSE 206 may connected to a user home Wi-Fi network gateway to access a Wi-Fi network 210. In some cases, the smart utility meter 208 may be the same or similar to the electricity metering devices 120 as described herein. In some cases, an EMS application of the smart utility meter 208 may receive a maximum load constraint for the site 202 at which it is installed. The maximum load constraint may be determined by a utility supplier 214 and may be determined based on panel and wiring limitations (e.g., a standard 100 A home). In some cases, the EVSE 206 may discover the smart utility meter 208 via the EMS application installed on the smart utility meter 208. In some cases, the EMS application may support multicast domain name system (mDNS) so that the EVSE 206 may automatically discover the EMS application utilizing the Wi-Fi network 210. In some cases, the EVSE 206 may initiate discovery and send an mDNS query 212 to the smart utility meter 208. In some cases, the mDNS query 212 may include information associated with the EVSE 206, such as, but not limited to, serial number, model, vendor, firmware version, meter type, meter serial number, etc. The EMS application may appropriately respond to the mDNS query 212 sent by the EVSE 206 with a return message 216 to establish a connection with the EVSE 206 via the Wi-Fi network 210. In some cases, the return message 216 may include information such as registration status (e.g., rejected or accepted) based on the EVSE 206 passing requirements to participant in the EMS (e.g., compatible model, compatible firmware, compatible serial number, etc.). Lightning bolts 201 and 203 signify communication between devices located at the site 202, the site 204, the utility supplier 214, and/or the CSMS 228.

In some cases, EVSE 206 may send out the mDNS query 212 and may receive responses from multiple devices connected to the Wi-Fi network 210. In this case, the EVSE 206 may cycle through each response and attempt to establish a mutual Transport Layer Security (mTLS) connection with the EMS application. If the connection is authenticated, then they are talking to the correct agent (e.g., via the EMS application pinning an EVSE certificate in the response). For example, EVSE certificates (sometimes referred to as client certificates) may be pinned using a serial number provided in a subject name of the certificate. Utility suppliers, such as the utility supplier 214, may share with EVSE OEMs a trust anchor certificate and the OEMs may share their trust certificate data with the utility supplier. The utility supplier may store OEM trust root certificates as part of EMS application. Both the utility suppliers and OEMs may account for certificate revocations and may allow a revocation list to be sent to their respective devices. In this way, the EVSE 206 may receive a response that includes the EVSE certificate and may establish a connection with the smart utility meter 208. In some cases, the EVSE will periodically send mDNS queries if it is not connected to an EMS application.

In some cases, the EMS application may send a max charge profile for a given interval of time to the EVSE 206. The max charge profile may include an EVSE maximum load for the determined interval (e.g., for offline and/or online charging). In such case it may be the EVSE's 206 responsibility to make sure that maximum allowed load communicated from EMS application is not violated and not overridden by signals (like smart charging profiles) from a CSMS 228. In some cases, the EMS application continues to monitor the site load, as well as EVSE 206 load via and if needed recalculates and sets a new max charge profile. For example, when a charging transaction is started by the EVSE 206, then the smart utility meter 208 may update available charging load for the EVSE 206 as well as actively monitor real time site load. In some cases, during off peak times, charging load for the EVSE 206 may be updated to a maximum value (e.g., 40 Amps). During peak times, depending on real time site load, the EVSE 206 load may stay reduced to a lower value (e.g., 10 Amps) until other non EVSE 206 loads on site are reduced.

In some cases, the EVSE 206 may be configured to operate on an offline maximum mode in cases of lost communication. For example, EVSE 206 and the smart utility meter 208 may communicate heartbeat messages to one another to determine if their connection is in place and healthy. When connection is not in place, the EVSE 206 may determine to use the offline maximum load (e.g., 10 Amps, 20 Amps, etc.) to not overload site wiring and equipment. In some cases, outside of charging transactions (e.g., periods where the charging station is not in use) the EVSE 206 may be configured to be operation in the offline maximum load. In cases where the smart utility meter 208 determines that the heartbeat messages are not being received from the EVSE 206, the smart utility meter 208 may send a message indicating the lack of connection to a backend server, such as the utility supplier 214. In cases of lost connection, the EVSE 206 may keep re-trying to discover the EMS application of the smart utility meter 208 to reestablish connection.

In some cases, the smart utility meter 208 may be arranged in a mesh network defining an autonomous routing area. However, in other examples, the meters may be arranged in a star network or other network topology. Regardless of the topology of the autonomous routing area, individual smart utility meters or “meter nodes” may be in communication by wireless (e.g., radio frequency) and/or wired (e.g., power line communication, Ethernet, serial, etc.) connections. For example, the smart utility meter 208 may be in communication (e.g., via wireless communication protocol 230) with a smart utility meter 220 at the site 204. Site 204 may also operate within the EMS and include an EVSE 222 used to charge a vehicle 224 and communicate with an EMS application of the smart utility meter 220 via a Wi-Fi network 226. In some cases, both the smart utility meter.

### Example Smart Utility Meter

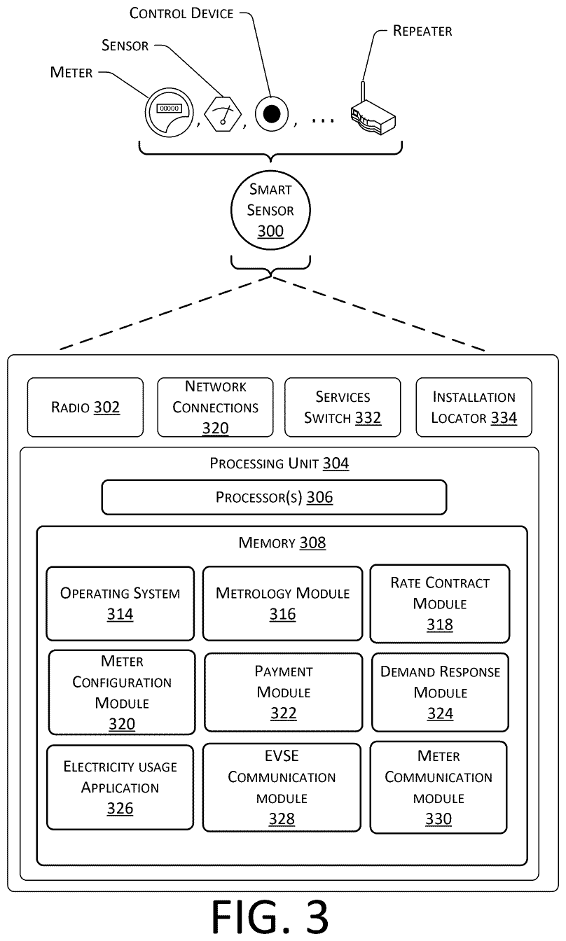

FIG. 3 is a diagram showing example details of an individual smart utility meter 300, which may be the same or similar to the electricity meter 126, the smart utility meter 208, and/or the smart utility meter 220. The term “smart utility meter” may comprise a smart utility meter (e.g., electricity meter, water meter, or gas meter), a relay, a repeater, a smart grid router, a transformer, or any other utility network computing device. The smart utility meter 300 may be configured for interaction with the utility supplier 214, EVSEs, other smart utility meters, as well as potentially other computing devices (e.g., consumer computing devices, utility network computing devices, web services, and the like).

As shown in the example of FIG. 3, the smart utility meter 300 may include a radio 302, a processing unit 304, a services switch 332, and an installation locator 334. The radio 302 may provide two-way RF communication with other smart sensors and/or other computing devices via a network. The installation locator 334 may include an RFID tag, as discussed above. The processing unit 304 may include one or more processors 306 and memory 308 and/or other hardware device(s), such as an application specific integrated circuit (ASIC), a gate array or other hardware-based logic device. The memory 308 may include an operating system (OS) 314. When present, the processor(s) 306 may comprise microprocessors, central processing units, graphics processing units, or other processors usable to execute program instructions to implement the functionality described herein. Additionally, or alternatively, in some examples, some or all of the functions described may be performed in hardware. In some cases, the memory 308 includes an operating system (OS) and one or more applications that are executable by the processor(s) 130. The memory 308 may also include a metrology module configured to receive, interpret, and/or otherwise process the metrology data collected by the smart utility meter 300. Additionally, or alternatively, one or more of the applications may be configured to receive and/or act on data collected by the smart utility meter 300. The memory 308 may also include one or more communication stacks (not shown). In some examples, the communication stack(s) may be configured to implement a 6LowPAN protocol, an 802.15.4e (TDMA CSM/CA) protocol, and/or an 802.15.4g protocol. However, in other examples, other protocols may be used, depending on the networks with which the device is intended to be compatible.

In embodiments in which the smart utility meter 300 comprises a utility meter, the smart utility meter 300 may include a metrology module 316 configured to receive consumption data of a resource (e.g., electricity, water, or gas) at a site of the meter. The metrology module 316 may report the consumption data to the utility supplier by RF transmission via the radio 302. The consumption data may be formatted and/or packetized in a manner or protocol for transmission over the utility communication network.

A rate contract module 318 may be configured to store a rate contract associated with the smart utility meter 300 and to receive updates to the rate contract. For instance, the smart utility meter 300 may apply the new rules of the new and/or updated rate contract via the rate contract module 318. The rate contract may specify an identifier of the smart utility meter 300, a type of the smart utility meter 300, a bill rate based on a time of day, a bill rate based on a forward consumption of a resource, a bill rate based on a reverse consumption of a resource, a bill rate based on a peak demand, a bill rate based on a power factor, a bill rate based on a class of customer, and/or a bill rate based on a type of payee.

A meter configuration module 320 may be configured to store meter configuration data associated with the smart utility meter 300 and to receive updates to the meter configurations. For instance, the smart utility meter 300 may apply the meter configurations via the meter configuration module 320. The meter configurations may specify an identifier of the smart utility meter 300, a type of the smart utility meter 300, a software update, a channel hopping sequence, a data rate, a signal strength, and/or a communication protocol.

A payment module 322 may be configured to perform payments transactions and store a balance associated with the smart utility meter 300. For instance, the payment transaction may include a transfer of funds into the balance associated with the smart utility meter 300. In response, the smart utility meter 300 may apply the funds to the balance via the payment module 322. The payment transaction may specify an identifier of the smart utility meter 300 and/or an amount of funds to be applied. The funds may be in the form of a currency such as a cryptocurrency, fiat, a token, etc. In some instances, if the balance of the smart utility meter 300 falls below a threshold, then the smart utility meter 300 may refrain from providing a resource to, or alter an amount of resource provided to, a site associated with the user by disconnecting the services switch 332. In some examples, the smart utility meter 300 may be configured to determine a temperature at the site (e.g. via a thermometer (not shown) or via communication to a weather service via a network) and the smart utility meter 300 may continue to provide the resource to the site if the temperature is below or above a predefined threshold value. In some cases, if the temperature is equal to the threshold value, the smart utility meter 300 may be configured defer to providing the resource to the site. In some cases, if the temperature is equal to the threshold value, the smart utility meter 300 may be configured defer to refrain from providing the resource to the site.

A demand response module 324 may be configured to enable initiation of a demand response event. For instance, the demand response module 324 of the smart utility meter 300 may determine load data that includes disaggregated load information for a plurality of loads that are receiving a resource at a site associated with the smart utility meter 300. The smart utility meter 300 may receive information detailing which loads of the plurality of loads to refrain from providing the resource too (i.e., shed) and for how long to refrain from providing the resource.

In some examples, the smart utility meter 300 may utilize a EVSE communication module 328 to communicate with local distributed energy resource (DER) devices (such as the EVSE 218) and may utilize a meter communication module 330 to communicate via an advanced metering infrastructure (AMI) network. For example, the meter communication module 330 may be configured to utilize hardware (HW) interfaces of the smart utility meter 300 in order to communicate, such as but not limited to Wi-Fi, Ethernet, Powerline, Zigbee, and/or Modbus. In some cases, the meter communication module 330 may be configured to communicate with multiple devices in parallel through HW interfaces (e.g., Wi-Fi) allowing to run multiple software (SW) communication protocols on top, such as but not limited to, OCPP, IEEE 2030.5, application protocol interfaces (APIs). In some cases, the smart utility meter 300 may receive, or collect, via the EVSE communication module 328, the meter communication module 330 and/or an electricity usage application 326 and store in the memory 308, various factors, parameters, and conditions including the overall load or the demand, the load forecast, the EV load, the battery levels of batteries connected to the electrical grid, the weather information including the current weather and forecast, and the like as described above. The smart utility meter 300 may also receive electricity usage data from the plurality of electricity metering devices via the meter communication module 330 and/or the electricity usage application 326. The electricity usage data may include present, or real-time, electricity consumption data associated with the plurality of premises, historical electricity consumption data associated with the plurality of premises, present, or real-time, electricity generation data associated with the one or more distributed generation systems (e.g., EVSE 218), and historical electricity generation data associated with the one or more distributed generation systems. The historical electricity consumption data may include electricity usage or consumption amount by the plurality of premises and electricity generated by the distributed generation system (when used as a supply) based on seasons, day-of-the-month, day-of-the-week, time-of-the-day, weather and temperature conditions, EV-related usage, and the like.

In some cases, the electricity usage application 326 may include load limiting logic configured to continually and/or periodically monitor total load at a site (e.g., 1 second intervals). In some examples, when an EV charging session is initiated by the customer, the electricity usage application 326 may determine a total site load relative to a maximum EV charging load. In response to the total premise load exceeding a rated capacity of the service panel, the electricity usage application 326 may throttle the EV charging load such that total premise load stays within rated capacity (e.g., within 1 second). In some cases, in response to the total premise load declining below the rated capacity of the service panel, the electricity usage application 326 may increase the EV charging limit.

### Example Processes

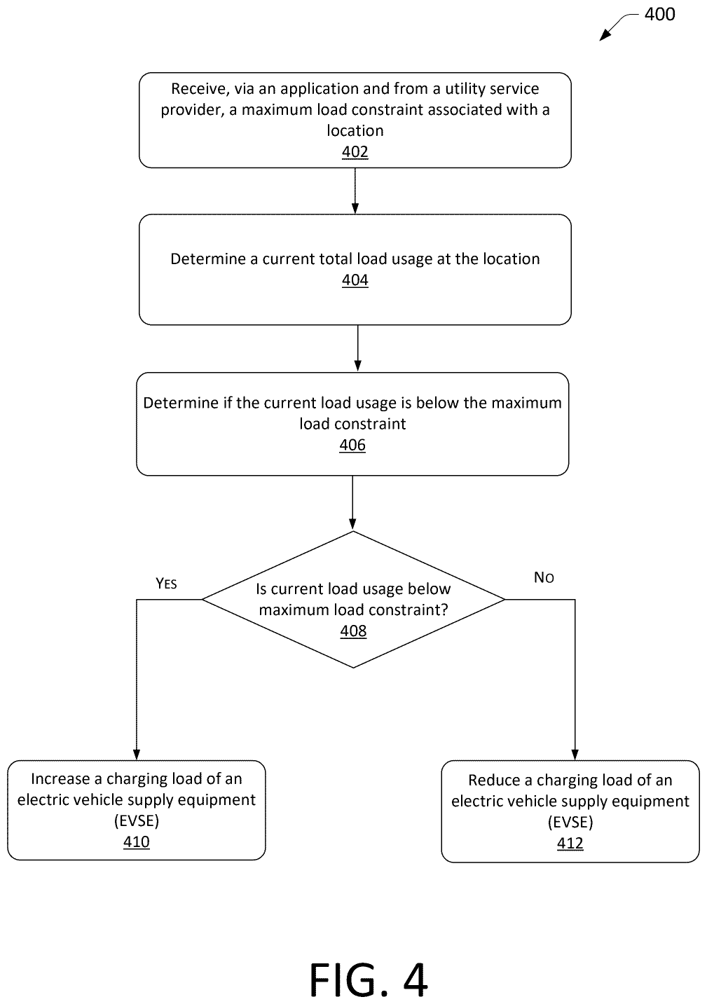

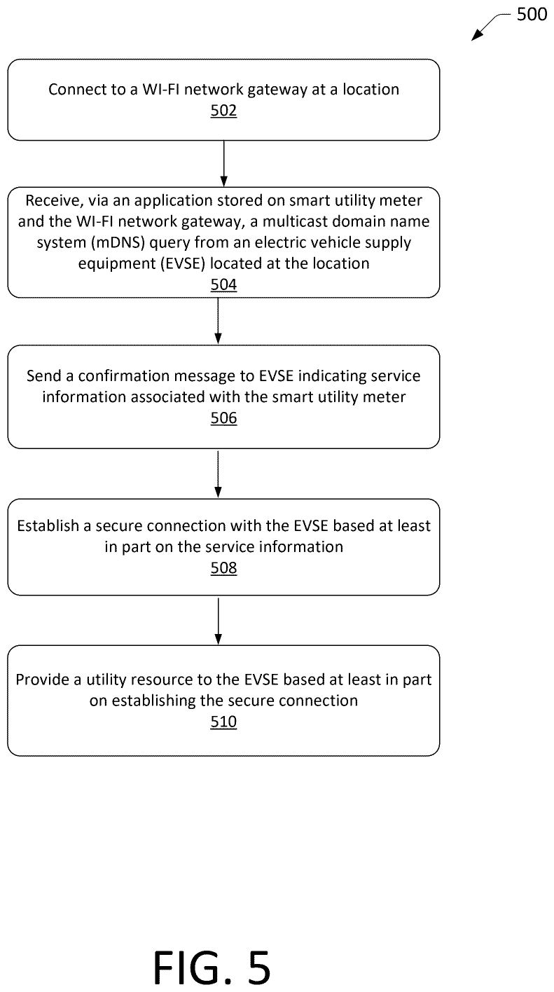

FIGS. 4 and 5 illustrate example processes 4 and 5 for employing the techniques discussed herein. For ease of illustration the processes 400 and 500 may be described as being performed by a device described herein, such as the electricity metering devices 120, the utility supplier 214, the utility meters 126, 208, or 220, and/or the EVSE 206. However, the processes 400 and 500 may be performed by other devices. Moreover, the devices may be used to perform other processes.

The processes 400 and 500 (as well as each process described herein) are illustrated a logical flow graph, each operation of which represents a sequence of operations that can be implemented in hardware, software, or a combination thereof. In the context of software, the operations represent computer-readable instructions stored on one or more computer-readable storage media that, when executed by one or more processors, perform the recited operations. Generally, computer-readable instructions include routines, programs, objects, components, data structures, and the like that perform particular functions or implement particular abstract data types. In some contexts of hardware, the operations may be implemented (e.g., performed) in whole or in part by hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The order in which the operations are described is not intended to be construed as a limitation, and any number of the described operations can be combined in any order and/or in parallel to implement the process. Further, any number of the described operations may be omitted.

FIG. 4 illustrates the example process 400 to increase or reduce an amount of load allocated to an EVSE based on a maximum load constraint.

At 402, the process 400 may include receiving, via an application and from a utility service provider, a maximum load constraint associated with a location. For example, an EMS application of the smart utility meter 208 may receive a maximum load constraint for the site 202 at which it is installed. The maximum load constraint may be determined by a utility supplier 214 and may be determined based on panel and wiring limitations (e.g., a standard 100 A home). The maximum load constraint may be a maximum load and/or maximum capacity that the network of smart utility sensors may collectively operate with by a transformer carrying the load. In some cases, the maximum load constraint may be determined based on one or more factors, such as temperature, voltage regulation, core saturation, load type (e.g., the nature of the load (resistive, inductive, or capacitive) affects how the transformer operates and inductive loads, for example, can cause additional heating and losses), regulatory and safety standards, etc. In some cases, the maximum load constraint may be specified as a Kilo-volt-amperes (kVA) rating, which reflects a transformer's capacity to handle both active and reactive power while in operation with the network of smart utility sensors without exceeding these limitations.

At 404, the process 400 may include determining a current total load usage at the location. For example, the smart utility meter may receive utility data from other non-EVSE loads at the site and may determine a total load associated with the site and/or transformer that is providing power to the site. For example, receiving the utility may include receiving data associated with electricity metering devices associated with the network of smart utility meters, a distributed generation system, electric vehicle (EV) telematics of an EV connected to an electrical grid, an EV supply equipment (EVSE) associated with the electrical grid, etc. In some cases, receiving the utility data may include receiving present electricity consumption data associated with the network of smart utility meters, historical electricity consumption data associated with the network of smart utility meters, present electricity generation data associated with a distributed generation system, historical electricity generation data associated with the network of smart utility meters, etc.

At 406, the process 400 may include determining if the current load usage is below the maximum load constraint. For example, the EMS application may compare a real time current load at the site with the maximum load constraint to determine if 1) there is extra load that can be used by EV charging load; 2) if load should be freed by EV charging to be available for non EV assets; or 3) if things should stay as is, without changing EVSE allowed loads. To calculate the maximum allowed EVSE current the EMS application may calculate: allowedEVSECurrent=(maxSiteCurrent−(realTimeSiteCurrent−EVSECurrent)). In some cases, the maximum load constraint my include a range of values, as opposed to a single value. For example, the range of values making up the maximum load constraint may be a range of 90 amps to 95 amps. In this case, step 406 of the process 400 may include determining if the current load usage is within the maximum load constraint range (e.g., between 90 and 95 amps).

At 408, the process 400 may include determining if the current load usage is below the maximum load constraint. For example, the smart utility meter may compare the total load usage at to the site to the maximum load constraint allocated for the site and determine if there is any additional load available that the EVSE can carry while remaining within the maximum load constraint.

At 410, the process 400 may include, in response to the current load usage being below the maximum load constraint, increasing the charging load of the EVSE. For example, EMS application may increase the maximum load constraint provided to the EVSE causing the EVSE to increase the charging load of the EVSE.

At 412, the process 400 may include, in response to the current load usage not being below the maximum load constraint, reducing a charging load of an EVSE such that current total load stays within the maximum load constraint associated with the location. For example, EMS application may decrease the maximum load constraint provided to the EVSE causing the EVSE to reduce a charging load of an electric vehicle supply equipment (EVSE).

FIG. 5 illustrates the example process 500 to establish a secure connection between device (e.g., a smart utility meter) and an EVSE.

At 502, the process 500 may include connecting to a WI-FI network gateway at a location. For example, the smart utility meter sensor may be configured to allocate a load capacity to the on-site smart sensors. For example, a user and/or installers may set Wi-Fi connectivity of a EVSE 206 and a smart utility meter 208. Both the smart utility meter 208 and the EVSE 206 may connected to a user home Wi-Fi network gateway to access a Wi-Fi network 210.

At 504, the process 500 may include receiving, via an application stored on a smart utility meter and the WI-FI network gateway, a multicast domain name system (mDNS) query from an electric vehicle supply equipment (EVSE) located at the location. For example, the EVSE 206 may discover the smart utility meter 208 via the EMS application installed on the smart utility meter 208. In some cases, the EMS application may support mDNS so that the EVSE 206 may automatically discover the EMS application utilizing the Wi-Fi network 210. The EVSE 206 may initiate discovery and send an mDNS query 212 to the smart utility meter 208. In some cases, the mDNS query 212 may include information associated with the EVSE 206, such as, but not limited to, serial number, model, vendor, firmware version, meter type, meter serial number, etc.

At 506, the process 500 may include sending a confirmation message to the EVSE indicating service information associated with the smart utility meter. For example, The EMS application may appropriately respond to the mDNS query 212 sent by the EVSE 206 with a return message 216 to establish a connection with the EVSE 206 via the Wi-Fi network 210. In some cases, the return message 216 may include information such as registration status (e.g., rejected or accepted) based on the EVSE 206 passing requirements to participant in the EMS (e.g., compatible model, compatible firmware, compatible serial number, etc.).

At 508, the process 500 may include establishing a secure connection with the EVSE based at least in part on the service information. For example, the EVSE 206 may send out the mDNS query 212 and may receive responses from multiple devices connected to the Wi-Fi network 210. In this case, the EVSE 206 may cycle through each response and attempt to establish a mTLS connection with the EMS application. If the connection is authenticated, then they are talking to the correct agent (e.g., via the EMS application pinning an EVSE certificate in the response). For example, EVSE certificates may be pinned using a serial number provided in a subject name of the certificate. Utility suppliers, such as the utility supplier 214, may share with EVSE OEMs a trust anchor certificate and the OEMs may share their trust certificate data with the utility supplier. The utility supplier may store OEM trust root certificates as part of EMS application. Both the utility suppliers and OEMs may account for certificate revocations and may allow a revocation list to be sent to their respective devices. In this way, the EVSE 206 may receive a response that includes the EVSE certificate and may establish a connection with the smart utility meter 208. In some cases, the smart utility meter 208 may request the mDNS query from the EVSE 206. For example, in cases where the EVSE 206 was installed long before the smart utility meter 208 was in place, the smart utility meter 208 may send a trigger message to the EVSE 206 causing the EVSE 206 to send the mDNS query.

At 510, the process 500 may include providing a utility resource to the EVSE based at least in part on establishing the secure connection. For example, the EMS application may send a max charge profile for a given interval of time to the EVSE 206. The max charge profile may include an EVSE maximum load for the determined interval (e.g., for offline and/or online charging). In such case it may be the EVSE's 206 responsibility to make sure that maximum allowed load communicated from EMS application is not violated and not overridden by signals (like smart charging profiles) from a CSMS 228. In some cases, the EMS application continues to monitor the site load, as well as EVSE 206 load via and if needed recalculates and sets a new max charge profile. For example, when a charging transaction is started by the EVSE 206, then the smart utility meter 208 may update available charging load for the EVSE 206 as well as actively monitor real time site load. In some cases, during off peak times, charging load for the EVSE 206 may be updated to a maximum value (e.g., 40 Amps). During peak times, depending on real time site load, the EVSE 206 load may stay reduced to a lower value (e.g., 10 Amps) until other non EVSE 206 loads on site are reduced.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
connecting to a WI-FI network gateway at a location;
receiving, via an application stored on a smart utility meter and the WI-FI network gateway, a multicast domain name system (mDNS) query from an electric vehicle supply equipment (EVSE) located at the location;
sending a confirmation message to the EVSE indicating service information associated with the smart utility meter;
establishing a secure connection with the EVSE based at least in part on the service information; and
providing a utility resource to the EVSE based at least in part on establishing the secure connection.

2. The method of claim 1, wherein the confirmation message includes at least one of a pointer record (PTR), a service record (SRV), a text record (TXT), or an address record (A).

3. The method of claim 1, further comprising:
receiving a client certificate and a trust anchor from the EVSE;
validating the client certificate based at least in part on determining that the client certificate includes a signature by the trust anchor and determining that the trust anchor can be trusted; and
establishing the secure connection with the EVSE based at least in part on the client certificate corresponding with a trust root certificate accessible by the application.

4. The method of claim 1, further comprising:
receiving, via the application and from a utility service provider, a maximum load constraint associated with the EVSE; and
sending the maximum load constraint associated with the EVSE to the EVSE.

5. The method of claim 4, further comprising:
receiving, via the application and from the utility service provider, the maximum load constraint associated with the location;
determining a current total load usage at the location;
comparing the maximum load constraint associated with the location to the maximum load constraint associated with the EVSE;
in response to determining that the maximum load constraint associated with the EVSE exceeds the maximum load constraint associated with the location, reducing a charging load of the EVSE such that current total load stays within the maximum load constraint associated with the location; and
in response to determining that the maximum load constraint associated with the EVSE does not exceed the maximum load constraint associated with the location, increasing the charging load of the EVSE such that current total load stays within the maximum load constraint associated with the location.

6. The method of claim 1, further comprising:
determining that the smart utility meter has lost the secure connection with the EVSE; and
sending a notification to a utility service provider that the EVSE has lost the secure connection with the smart utility meter.

7. The method of claim 1, further comprising:
determining that the EVSE is performing a charging transaction;
determining an updated maximum load constraint associated with the EVSE; and
sending the updated maximum load constraint associated with the EVSE to the EVSE during the charging transaction.

8. A method comprising:
receiving, via an application and from a utility service provider, a maximum load constraint associated with a location;
determining a current total load usage at the location; and
determining if the current load usage is below the maximum load constraint, wherein:
in response to the current load usage being above the maximum load constraint, reducing a charging load of an EVSE such that current total load stays within the maximum load constraint associated with the location; or
in response to the current load usage being at or below the maximum load constraint, increasing the charging load of the EVSE.

9. The method of claim 8, further comprising:
receiving a real time indication from the EVSE that the EVSE is performing a transfer of energy to an EV and consuming energy from site;
determining if an amount of energy being consumed is above an expected energy consumption;
in response to the energy being consumed being above the expected energy consumption, generating an updated maximum load constraint associated with the EVSE; and
sending the updated maximum load constraint associated with the EVSE to the EVSE.

10. The method of claim 8, further comprising:
connecting, via a smart utility meter, to a WI-FI network gateway at the location;
receiving, via an application stored on the smart utility meter and the WI-FI network gateway, a multicast domain name system (mDNS) query from the EVSE at the location;
sending, via the smart utility meter, a confirmation message to the EVSE indicating service information associated with the smart utility meter;
establishing, via the smart utility meter, a secure connection with the EVSE based at least in part on the service information; and
providing, via the smart utility meter, a utility resource to the EVSE based at least in part on establishing the secure connection.

11. The method of claim 10, wherein the confirmation message includes at least one of a PTR, SRV, TXT, or A records.

12. The method of claim 8, further comprising:
receiving a client certificate and a trust anchor from the EVSE;
validating the client certificate based at least in part on determining that the client certificate includes a signature by the trust anchor and that the trust anchor is a trusted anchor; and
establishing a secure connection with the EVSE based at least in part on the client certificate corresponding with a trust root certificate.

13. The method of claim 8, further comprising:
determining that a smart utility meter has lost a secure connection with the EVSE; and
sending a notification to a utility service provider that the EVSE has lost the secure connection with the smart utility meter.

14. The method of claim 8, further comprising:
determining that the EVSE is performing a charging transaction;
determining an updated maximum load constraint associated with the EVSE; and
sending the updated maximum load constraint associated with the EVSE to the EVSE during the charging transaction.

15. The method of claim 14, wherein the updated maximum load constraint is received from at least one of a utility supplier or a neighboring smart utility meter.

16. A smart utility meter comprising:
one or more processors; and
memory communicatively coupled to the one or more processors, the memory storing thereon computer executable instructions that, when executed by the one or more processors, cause the one or more processors to perform operations comprising:
connecting to a WI-FI network gateway at a location;
receiving, via an application and the WI-FI network gateway, a multicast domain name system (mDNS) query from an electric vehicle supply equipment (EVSE) located at the location;
sending a confirmation message to EVSE indicating service information associated with the smart utility meter;
establishing a secure connection with the EVSE based at least in part on the service information; and
providing a utility resource to the EVSE based at least in part on establishing the secure connection.

17. The smart utility meter of claim 16, the operations further comprising:
receiving a client certificate and a trust anchor from the EVSE;
validating the client certificate based at least in part on determining that the client certificate includes a signature by the trust anchor and that the trust anchor is a trusted anchor; and
establishing the secure connection with the EVSE based at least in part on the client certificate corresponding with a trust root certificate accessible by the application.

18. The smart utility meter of claim 16, the operations further comprising:
receiving, via the application and from a utility service provider, a maximum load constraint associated with the EVSE; and
sending the maximum load constraint associated with the EVSE to the EVSE.

19. The smart utility meter of claim 18, the operations further comprising:
receiving, via the application and from the utility service provider, the maximum load constraint associated with the location;
determining a current total load usage at the location;
comparing the maximum load constraint associated with the location to the maximum load constraint associated with the EVSE;
in response to determining that the maximum load constraint associated with the EVSE exceeds the maximum load constraint associated with the location, reducing a charging load of the EVSE such that current total load stays within the maximum load constraint associated with the location; and
in response to determining that the maximum load constraint associated with the EVSE does not exceed the maximum load constraint associated with the location, increasing the charging load of the EVSE such that current total load stays within the maximum load constraint associated with the location.

20. The smart utility meter of claim 16, the operations further comprising:
determining that the smart utility meter has lost the secure connection with the EVSE; and
sending a notification to a utility service provider that the EVSE has lost the secure connection with the smart utility meter.

21. A smart utility meter comprising:
one or more processors; and
memory communicatively coupled to the one or more processors, the memory storing thereon computer executable instructions that, when executed by the one or more processors, cause the one or more processors to perform operations comprising:
determining a current total load usage at the location; and
determining if the current load usage is below the maximum load constraint, wherein:
in response to the current load usage being above the maximum load constraint, reducing a charging load of an EVSE such that current total load stays within the maximum load constraint associated with the location; or
in response to the current load usage being at or below the maximum load constraint, increasing the charging load of the EVSE.

22. The smart utility meter of claim 21, the operations further comprising:
receiving a real time indication from the EVSE that the EVSE is performing a transfer of energy to an EV and consuming energy from site;
determining if an amount of energy being consumed is above an expected energy consumption;
in response to the energy being consumed being above an expected energy consumption, generating an updated maximum load constraint associated with the EVSE; and
sending the updated maximum load constraint associated with the EVSE to the EVSE.

23. The smart utility meter of claim 21, the operations further comprising:
connecting to a WI-FI network gateway at the location;
receiving, via an application stored on the smart utility meter and the WI-FI network gateway, a multicast domain name system (mDNS) query from the EVSE at the location;
sending a confirmation message to the EVSE indicating service information associated with the smart utility meter;
establishing a secure connection with the EVSE based at least in part on the service information; and
providing a utility resource to the EVSE based at least in part on establishing the secure connection.

24. The smart utility meter of claim 21, wherein the confirmation message includes at least one of a PTR, SRV, TXT, or A records.

25. The smart utility meter of claim 21, the operations further comprising:
receiving a client certificate and a trust anchor from the EVSE;
validating the client certificate based at least in part on determining that the client certificate includes a signature by the trust anchor and that the trust anchor is a trusted anchor; and
establishing a secure connection with the EVSE based at least in part on the client certificate corresponding with a trust root certificate.
